(19) United States
(12) Patent Application Publication
(10) Pub. No.: US 2009/0160756 A1
(43) Pub. Date: Jun. 25, 2009

(54) DISPLAY DEVICE WITH A BACKLIGHT

(75) Inventors: Wilhelmus Henricus Maria Van Beek, Eindhoven (NL); Wouter Oepts, Best (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/300,154

(22) PCT Filed: Apr. 23, 2007
(86) PCT No.: PCT/IB07/51477

§ 371 Date: Nov. 10, 2008

(30) Foreign Application Priority Data
May 9, 2006 (EP) 06113692.5

(51) Int. Cl. G09G 3/36

(52) U.S. Cl. 345/102

(57) ABSTRACT

A display device comprises an image display unit (2) configured to display an image, a backlight (6) comprising at least one group of light emitting sources arranged on a substrate (3), said group comprising at least a red, a green, a blue and a white light emitting source, and backlight control means (7). The backlight control means are configured to identify respective specific drive levels of the red, green and blue light sources, select a drive level for the white light source in dependence thereof and generate actual drive levels of the red, green and blue light sources.

The present invention relates to a display device comprising an image display unit and a backlight unit comprising red, green, blue and white light emitting sources arranged on a substrate.

Liquid crystal display (LCD) screens are passive display systems meaning they do not emit light themselves.

These display screens are based on the principle that light passes or does not pass a layer of liquid crystals. This means that a light source is required for generating an image. In reflective LCD screens, ambient light is used as an external light source. In transmissive LCD screens, artificial light is generated by a backlight system.

Several variants of backlight systems exist, for example a backlight system comprising a light source which supplies light to the backside of an image display unit for generating background illumination. The light source covers the back of the image display unit and may provide different levels of illumination to different parts of the backside of the image display unit. This facilitates adjustment of the backlight with respect of brightness, or illumination, as well as adjustment of color gamut, for different parts of the image display unit. The adjustment is performed based on a video image displayed by the image display unit.

The light of the LCD backlight is generally generated by a white light source. Such a source can be a white light emitting diode (LED) for mobile applications and a cold cathode fluorescent lamp (CCFL) for monitor and TV LCDs. Generally these white light sources have a broad emission spectrum.

Recently backlights based on colored light sources such as red, green and blue (RGB) LEDs have been introduced. The emission spectra of an RGB LED backlight appears as three sharp peaks around the emission wavelengths of the red, green and blue LEDs. Light emitted by the individual color LEDs is mixed together for generating light perceived as white light. As compared to wide-spectrum white light sources, the resulting image using such a RGB LED backlight can shows more saturated colors and thereby provide an improved image with a larger color gamut.

US2004/0061814 and US2005/0184952 disclose further background art.

A problem with prior art RGB backlight devices is a high power consumption. Even though improved picture performance is provided, introduction of RGB backlight in low power LCDs and mobile display applications is hampered thereby.

It is an object of the invention to provide a display device comprising a backlight having a relatively low power consumption while still providing a large color gamut for the display device. According to the invention there is provided a display device comprising

an image display unit configured to display an image,

a backlight comprising at least one group of light emitting sources arranged on a substrate, said at least one group comprising at least a red, a green, a blue and a white light emitting source, and

a backlight control unit configured to:

identify red, green and blue specific drive levels for the red, green and blue light sources in said at least one group of light emitting sources,

set a white drive level for said at least one white light source in said at least one group in dependence of the red, green and blue specific drive levels, and

generating red, green and blue actual drive levels from the red, green and blue specific drive levels and the white drive level.

Broadly, the invention proposes the use of colored light sources such as red, green and blue LEDs in combination with a broad-spectrum white light source such as a white LED or a CCFL lamp. Generally, a white light source has higher efficacy (lumen per Watt) in generating white light than a combination of red, green and blue LEDs. This insight is advantageously used by providing as much image brightness as possible through the white light sources, while mainly relying on the colored light sources for increasing the color gamut.

The display device in a preferred embodiment includes an intelligent image processing unit that determines the optimum brightness and/or color for the backlight illumination from the image data to be displayed.

The backlight control unit accordingly identifies RGB data representing specific drive levels for the red, green and blue light sources. In the preferred embodiment, the image processing unit provides the desired backlight brightness and/or color to the backlight control unit.

Then, the backlight control unit selects a white drive level for the white light source in dependence of the red, green and blue specific drive levels, and modifies the latter accordingly.

In a preferred embodiment, the white drive level W is selected to be equal to the lowest value of the red, green and blue specific drive levels Rspec, Gspec and Bspec. Subsequently, the actual red, green and blue drive levels R, G and B are obtained by subtracting the white drive level W from the red, green and blue specific drive levels. Expressed as a formula,

W=MIN(Rspec,Gspec,Bspec); R=Rspec−W; G=Gspec−W; B=Bspec−W

where R, G and B represent the actual drive values for the red, green and blue light sources respectively.

Many alternative algorithms are possible, so that for every application an optimum balance can be struck between power saving and color richness. For example, the backlight control unit for an LCD panel for a notebook computer may choose the drive levels so as to result in the best possible color gamut when the notebook computer is on AC power, and may switch to a more power efficient backlighting scheme (e.g. increase use of the white light source) when the notebook computer is running on its battery.

Referring to the above formula and representing the maximum drive level for a light source by MAX, an exemplary algorithm for calculating the white drive level W may be:

$$W = MAX * {( \frac{MIN ( Rspec , Gspec , Bspec )}{MAX} )}^{n}$$

following which operation the actual drive levels for the red, green and blue light sources are calculated as above. In the ideal case, n=1, and the white drive level will be the same as calculated above. This provides the largest possible color gamut. If power needs to be saved, e.g. if a notebook computer is running on battery power, the algorithm may choose n<1 so as to make more intensive use of the white light sources. Any negative drive values for the red, green and blue light sources will then be clipped to zero. Note that this will not lead to color errors on the display, as the final pixel color is determined by the pixels of the LCD panel itself. When n<1, only the color gamut of the display will be reduced.

More specifically, the display device according to the invention requires approximately only 50% of the power required by prior art displays with an RGB backlight. Furthermore, the configuration of the control means provides for efficient settings of drive levels.

The drive levels may be represented by specific electric voltages or currents, which provides for efficient control of the setting of drive levels.

The light emitting sources may be inorganic light emitting diodes (LEDs), for facilitating precise and low cost light sources. In one embodiment, only the red, green and blue light emitting sources are LEDs, and the white light source comprises for example CCFL or HCFL lamps. In another embodiment, the red, green, blue and white light source are all LEDs.

The backlight may comprise at least one segment, each segment comprising groups of light emitting sources, which provides for a more versatile control of the light sources.

The number of segments and/or the shape of the segments may depend on the image, for providing the most proper backlight for respective part of the image.

The display may further comprise video image processing means configured to analyze the image and input, to the backlight control means, initial drive levels of the red, green and blue light sources, which provides for efficient control of setting the initial drive levels.

The backlight control means may be configured to decrease light source drive levels based on image content, in order to save power. The dimming is done, for example, for dark sections of the image and improves the energy saving properties of the invention.

The image processing means may further be configured to clip the image, for removing image data that is not necessary for displaying the image.

The invention also provides a method of controlling a backlight device in a display device comprising an image display unit, said backlight device comprising at least one group of light emitting sources arranged on a substrate, said at least one group comprising at least a red, a green, a blue and a white light emitting source, said method comprising the steps of:

identifying red, green and blue specific drive levels for the red, green and blue light sources in said at least one group of light emitting sources,

setting a white drive level for said at least one white light source in said at least one group in dependence of the red, green and blue specific drive levels, and

generating red, green and blue actual drive levels from the red, green and blue specific drive levels and the white drive level.

The inventive method for controlling the backlight device in a display device provides the same advantages as the inventive display device, and the method may incorporate any of the features described above in association with the display device. The invention also provides a mobile terminal comprising a display device incorporating any one of the associated features described above.

Embodiments of the present invention will now be described, by way of example, with reference to the accompanying schematic drawings, in which

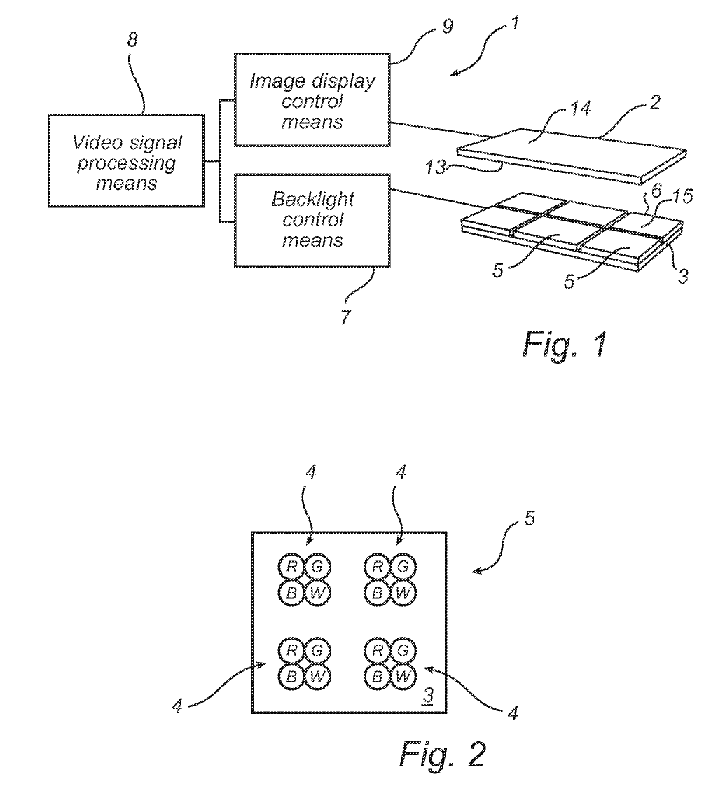

FIG. 1 illustrates a schematic view of a display device according to the invention,

FIG. 2 illustrates a schematic front view of a segment comprising light emitting sources,

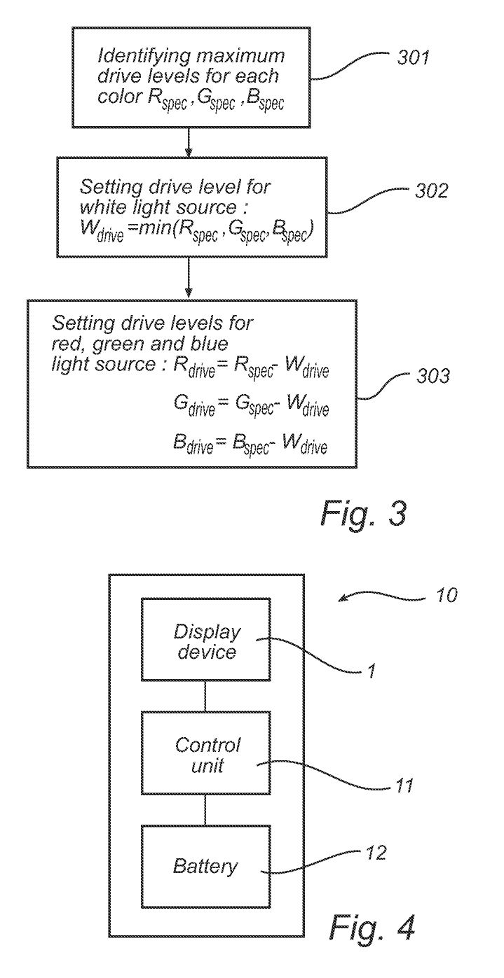

FIG. 3 is a schematic drawing of a diagram of the method of controlling a backlight device, and

FIG. 4 is a schematic view of a mobile terminal.

FIG. 1 illustrates a display device 1 comprising video signal processing means 8 connected to image control means 9 and to backlight control means 7. The image control means 9 controls in a known manner an image display unit 2.

The backlight control means 7 is connected to a backlight 6 arranged on a back side 13 of the image display unit 2. A front side 14 of the image display unit 2 is during operation viewed by a viewer watching a picture according to a video signal supplied by the video signal processing means 8. A front side 15 of the backlight 6, facing the back side 13 of the image display unit 2, comprises a plurality of segments 5.

With reference to FIG. 2, each segment 5 comprises groups of light sources 4, and each group 4 has a respective red R, green G, blue B and white W light source. The light sources are preferably LEDs and are arranged on a suitable substrate 3. Drive levels are in a known manner electronically set for each light source by means of the backlight control means 7, and preferably the video signal processing means 8 provides input data for the backlight control means 7, based on video content. This enables the backlight 6 to emit a desired light intensity and color to different regions of the image display unit 2.

To avoid regions with a different luminous intensity for the different colors, the light sources within respective group 4 are positioned very close together. This is, for instance, achieved by making a single package with red, green, blue and white LED dies placed next to each other. It is, of course, also possible to arrange single red, green, blue and white LED dies on the substrate 3. Alternative embodiments may consist of a different number of white and color LEDs, for instance two white LEDs and three red, green and blue LEDs, for purpose of achieving a suitable efficiency of the LEDs desired luminance of the backlight.

To drive the red R, green G, blue B and white W (RGBW) LEDs, an algorithm analyzes the video frames to determine the drive levels for the LEDs. To correctly drive the RGBW backlight, dimming is employed, meaning the backlight intensity is decreased when the video image displayed does not need the highest luminance level. It is also possible to drive segments of the picture independently and to dynamically change which groups 4 of light sources belong to a specific backlight segment 5, thereby changing the shape and size of the segments 5 according to the requirements of the video image.

The algorithm analyzes each video frame/segment and stores a specific drive level, or value, for red, green and blue. The drive level for the white LED is set to the minimum level of the three stored levels (for red, green and blue). In most cases, the three drive levels are not the same. This means, mostly two colors (sometimes one or zero) must be added to get the desired backlight color for the current video frame. The added colors (red, green, blue, red-green, red-blue, green-blue) are added with the separate red, green and blue LED. Because the algorithm also uses dimming, video data is scaled back to the LED drive range (0-255), resulting in a correct image on the LCD display with the RGBW backlight.

Preferably the image processing means 8 clips the image for removing unnecessary image data, which improves picture performance. Any suitable clipping algorithm may be used, and clipping values may vary for different segments 5.

Preferable a suitable algorithm is employed to create a fading effect between a segment with active backlight LEDs and a segment with inactive or nearly inactive backlight LEDs. In brief, the active LEDs closest to the inactive segment are given gradually lower drive levels in order to prevent a sharp line between the active and inactive segment.

FIG. 3 illustrates a schematic drawing of a diagram of the method of controlling the backlight device 6, wherein, for all LEDs in a frame/segment:

specific drive levels for red (Rspec), green (Gspec) and blue (Bspec) are identified 301 by traversing all RGB LEDs in the frame/segment,
drive level for white LEDs in the frame/segment (Wdrive) is set 302 to the smallest one of Rspec, Gspec and Bspec,

drive level for red LEDs in the frame/segment (Wdrive) is set 302 to Rspec-Wdrive,

drive level for green LEDs in the frame/segment (Wdrive) is set 302 to Gspec-Wdrive, and

drive level for blue LEDs in the frame/segment (Wdrive) is set 302 to Bspec-Wdrive.

With this method, it is easy to generate more light if this is desirable, by driving all the four LEDs of a group to make light, instead of only the white LED. This may, of course, be done locally for only specific segments.

The above discussed specific drive levels are determined by pre-set rules. Preferably the specific drive levels are maximum drive levels, i.e. Rspec is the maximum drive level for red, Bspec is the maximum drive level for blue, and Gspec is the maximum drive level for green.

However, the specific drive level for a color may be, for example, 90% of the maximum drive level for that color, a mean value of the 15% highest drive levels for that color, or any other value determined on basis of the different drive levels (within the segment) for that color.

Tests show that an RGBW backlight requires approximately only 50% of the energy required for an RGB backlight, for example when a backlight luminance of 1500 CD/m2 is required. When dimming is employed, further reduction of the power consumption is achieved.

With reference to FIG. 4, a mobile terminal 10 is illustrated and comprises a control unit 11 powered by a battery 12. The control unit 11 supplies power to, and controls, a display device 1 according to above. Examples of mobile terminals are digital personal agendas, mobile phones, hand held computers, laptop computers, portable video game units, global positioning systems and portable music systems.

1. A display device comprising
an image display unit (2) configured to display an image,
a backlight (6) comprising at least one group (4) of light emitting sources arranged on a substrate (3), said at least one group (4) comprising at least a red (R), a green (G), a blue (B) and a white (W) light emitting source, and
a backlight control unit (7) configured to:
identify red, green and blue specific drive levels (Rspec, Gspec, Bspec) for the red, green and blue light sources in said at least one group (4) of light emitting sources,
set a white drive level (Wdrive) for said at least one white light source in said at least one group (4) in dependence of the red, green and blue specific drive levels, and
generating red, green and blue actual drive levels (R, G, B) from the red, green and blue specific drive levels (Rspec, Gspec, Bspec) and the white drive level.

2. A display device according to claim 1, wherein the backlight control unit (7) is further configured to activate the at least one white light source using the white drive level, and the at least one red, green and blue light sources using the red, green and blue actual drive levels.

3. A display device according to claim 1, wherein the backlight control unit (7) is configured to set the red, green and blue drive levels (R, G, B) to a corresponding one of the red, green and blue specific drive levels (Rspec, Gspec, Bspec), decreased by the white drive level (W).

4. A backlight device according to claim 1, wherein the light emitting sources are inorganic light emitting diodes.

5. A display device according to claim 1, wherein the backlight comprises at least one segment (5), each segment (5) comprising groups of light emitting sources.

6. A display device according to claim 5, wherein the number of segments (5) depend on a content of the image.

7. A display device according to claim 5, wherein the shape of the segments (5) depend on a content of the image.

8. A display device according to claim 1, further comprising video image processing means (8) configured to analyze the image and input to the backlight control means (7), the red, green and blue specific drive levels (Rspec, Gspec, Bspec).

9. A display device according to claim 8, wherein the backlight control means (7) is configured to decrease light source drive levels based on image content.

10. A method of controlling a backlight device (6) in a display device (1) comprising an image display unit (2), said backlight device (6) comprising at least one group (4) of light emitting sources arranged on a substrate (3), said at least one group (4) comprising at least a red (R), a green (G), a blue (B) and a white (W) light emitting source, said method comprising the steps of:
identifying (301) red, green and blue specific drive levels (Rspec, Gspec, Bspec) for the red, green and blue light sources in said at least one group (4) of light emitting sources,
setting (302) a white drive level (Wdrive) for said at least one white light source in said at least one group (4) in dependence of the red, green and blue specific drive levels, and
generating (303) red, green and blue actual drive levels (R, G, B) from the red, green and blue specific drive levels (Rspec, Gspec, Bspec) and the white drive level.

11. A mobile terminal comprising a display device (1) according to claim 1.
